(19) United States
(12) Patent Application Publication
(10) Pub. No.: US 2011/0068305 A1
(43) Pub. Date: Mar. 24, 2011

(54) Polymerizable composition and its uses

(75) Inventors: Kun-Ming Yeh, Kaohsiung City (TW); Yi-Chung Shih, Kaohsiung City (TW)

(73) Assignee: Eternal Chemical Co., Ltd., Kaohsiung City (TW)

(21) Appl. No.: 12/805,353

(22) Filed: Jul. 27, 2010

(30) Foreign Application Priority Data
Sep. 18, 2009 (TW) 098131593

(51) Int. Cl. C08F 2/50; C08F 299/04; G02F 1/361

(52) U.S. Cl. 252/582; 522/104; 522/107; 522/101; 522/93

(57) ABSTRACT

The present invention provides a polymerizable composition, comprising, based on the total weight of the polymerizable composition:
(a) 1-90 wt % of a monomer of a formula (I):

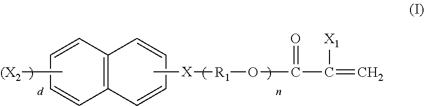

wherein
X₁ is H or methyl;
X₂ is H or C₁-C₂ alkyl;
X is O or S;
R₁ is C₁-C₁₂ straight or branched alkylene or alkoxylene; and
d and n are each independently an integer of 0 to 3; and
   (b) 0.1-10 wt % of a photo-initiator.

The present invention also provides an optical film comprising a coating formed from the above polymerizable composition. The optical film can be used in backlight units for displays as a brightness enhancement film.

### CROSS-REFERENCE TO RELATED APPLICATION

The present application claims priority to, and the benefit of, Taiwan Application No. 98131593, filed Sep. 18, 2009. The content of this application is herein incorporated by reference in its entirety.

### FIELD OF THE INVENTION

The present invention relates to a polymerizable composition and an optical film comprising a coating formed from the polymerizable composition. The optical film can be used in backlight units for displays as a brightness enhancement film.

### BACKGROUND OF THE INVENTION

Liquid crystal displays get an advantage in being light, thin, short, small, in having low thermal energy consumption, low power consumption and almost no radiation damage, etc., and thus have replaced cathode ray tube displays in mainstream market.

In the backlight units, making use of a variety of optical films to enhance a luminance of panels has become a most economical and simplest development program for product. According to this way, not only any element need not be altered in design, but also extra powder need not be consumed, also, light source can exert most efficient effect on enhancing the luminance of the panel of LCDs.

A brightness enhancement film is usually abbreviated to BEF or is referred to as a light-gathering film, which is obtained by applying a particular acrylic resin coating onto a polyester substrate and then curing it to a prismatic microstructure with high energy ultraviolet (UV) rays. The main function of the brightness enhancement film is to collect by means of refraction and internal total reflection scattered light rays emitted in all directions by light guides and converge the collected light rays in the on-axis direction of about ±35 degrees to enhance the luminance of the panel of LCDs.

The brightness enhancement film generally used is prepared by curing a polymerizable composition with ultraviolet rays. In general, if a polymerizable composition coating with higher refractive index is chosen, the brightness enhancement film can achieve a better brightness enhancing effect.

So far it is well known to add halogen-containing monomers or oligomers to polymerizable compositions in order to obtain a polymerizable composition coating with higher refractive index, however the presence of halogen in the monomers brings about environmental pollutions.

Further, 4,4′-bis(methacroylthio)diphenyl sulfide (MPSMA) monomer having the following structure:

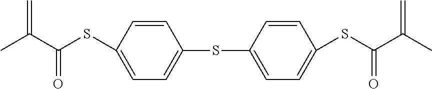

can be used.

For example, U.S. Pat. No. 5,183,917 discloses a process for synthesizing the aforesaid monomer and a composition comprising the same. MPSMA monomer is a crystalline solid and has a high refractive index, but is not very soluble in other monomers to make it unfavorable for coating. U.S. Pat. No. 5,969,867 discloses making use of bis(methacryloxyethoxyphenyl) propane monomer to dissolve MPSMA. However, the refractive index of bis(methacryloxyethoxyphenyl) propane monomer is low, and therefore it is necessary to use MPSMA monomer in a large amount to enhance the refractive index of the polymerizable composition. Moreover, U.S. Pat. No. 6,541,591 and U.S. Pat. No. 6,953,623 both disclose making use of MPSMA monomer to enhance the refractive index of the polymerizable composition coating. However, MPSMA monomer is expensive and in turn is unfavorable for vast use in industry.

Furthermore, refractive index can be increased by adding inorganic nanoparticles, for example, U.S. Pat. No. 7,282,272 discloses that the refractive index of a brightness enhancement film is increased by adding inorganic nanoparticles. However, the drawback of this technique is that the nanoparticles are not easily and uniformly dispersed in coatings thereby affecting the convenience in operation.

Based on the foregoing, it is an intensive demand in the art to provide polymer coatings with high refractive index, which do not have the aforesaid drawback and are easily operated in a relatively low cost so as to further raise gains from enhancing luminance of brightness enhancement films.

### SUMMARY OF THE INVENTION

Therefore, the main object of the invention is to provide a polymerizable composition with a high refractive index. Another object of the invention is to provide an optical film comprising a substrate and at least a lay of the coating formed from the polymerizable composition, the optical film being used in backlight units for displays as a brightness enhancement film.

### BRIEF DESCRIPTION OF DRAWINGS

FIG. 1 is a schematic view of an embodiment of the optical film of the invention.

### DETAILED DESCRIPTION OF THE INVENTION

After referring to the drawing and the mode for implementation, those people with ordinary common sense in the art may realize the basic spirit of the invention and the technical measures used, and the embodiments for implementation.

The terms used herein are intended merely to describe the embodiments for implementation without limiting the scope of the invention to be protected.

The term “prismatic columnar structure”, as used herein, is composed of two slant surfaces wherein the slant surface is a flat surface or a curved surface, and the two slant surfaces meet at the top of the prism to form a peak or an arc, and each surface meets with another slant surface of an adjacent prismatic columnar structure at the bottom to form a pit.

Specifically, the invention provides a polymerizable composition comprising:

(a) 1-90 wt % of a monomer of a formula (I):

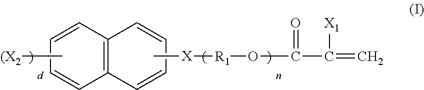

wherein
X₁ is H or methyl;
X₂ is H or C₁-C₂ alkyl;

### X is O or S;

R₁ is C₁-C₁₂ straight or branched alkylene or alkoxylene; and
d and n are each independently an integer of 0 to 3; and

(b) 0.1-10 wt % of a photo-initiator,

based on the total weight of the polymerizable composition.

In general, preference is given to the monomer of the formula (I) where X is O, X₂ is H, and d is an integer of 1 due to the fact that the polarizability of sulfur atoms is relatively high, therefore the refractive index becomes relatively high. According to one embodiment of the invention, the monomer of the formula (I) is a monomer having a formula (I₁):

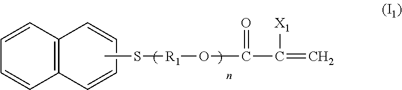

wherein R₁ is preferably methylene, ethylene, propylene or isopropylene; n is a integer of 1 to 2; and X₁ is H or methyl.

In a further preferred embodiment, the monomer of the formula (I) wherein R₁ is ethylene; n is 1; and X₁ is H (i.e., the monomer of the formula (I₂)) can be used

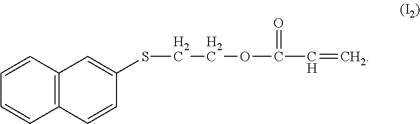

The above monomer has a high refractive index of between 1.57 and 1.63, and thus the refractive index of the coating obtained after curing the polymerizable composition can be effectively increased. In general, in order to make the polymerizable composition have high refractive index, the monomer of the formula (I) is in an amount of at least 1 wt %, preferably from 8 wt % to 70 wt %, more preferably from 30 wt % to 60 wt %, based on the total weight of the polymerizable composition. If the amount of the monomer of the formula (I) is less than 1 wt %, it is difficult for the polymerizable composition to have a high refractive index. If the amount of the formula (I) is more than 90 wt %, the polymerizable composition will not be completely cured and thus is unfavorable for coating.

The (b) photo-initiators useful for the polymerizable composition of the invention are those which generate free radicals upon light irradiation to induce polymerization reactions through the propagation of free radicals, and are for example selected from the group consisting of benzophenone, benzoin, benzil, 2,2-dimethoxy-1,2-diphenylethan-1-one, 1-hydroxycyclohexyl phenyl ketone, 2,4,6-trimethylbenzoyl diphenyl phosphine oxide (TPO), and a combination thereof, preferably benzophenone.

The amount of the photo-initiator of the invention is not particularly limited and can be adjusted depending on the type and the amount used of the polymerizable monomers included in the polymerizable composition. In general, the amount of the photo-initiator is between 0.1 wt % and 10 wt %, preferably between 1 wt % and 5 wt %, based on the total weight of the polymerizable composition.

In order to increase the reactivity of the polymerizable composition and to make the composition have good thermal resistance and maintain high refractive index after the polymerizable composition is cured, (c) other monomers can be optionally added into the composition of the invention. Further in order to maintain the high refractive index of the polymerizable composition of the invention, (c) other monomers preferably have a refractive index of not less than 1.6, for example the monomer of the formula (II):

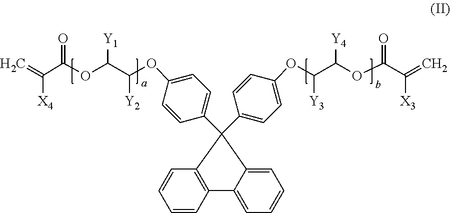

wherein
X₃ and X₄ are each independently H or C₁-C₄ alkyl, preferably independently H or methyl;
Y₁, Y₂, Y₃ and Y₄ are each independently H, C₁-C₄ alkyl or OH, preferably independently H or methyl; and
a and b are each independently an integer of 0 to 5, preferably independently an integer of 1 to 3.

Preferably, in the monomer of the formula (II), X₃, X₄, Y₁, Y₂, Y₃ and Y₄ are each independently H or methyl; and a and b are each independently an integer of 1 to 3.

According to one embodiment of the invention, the monomer of the formula (II) is a monomer having a formula (II₁):

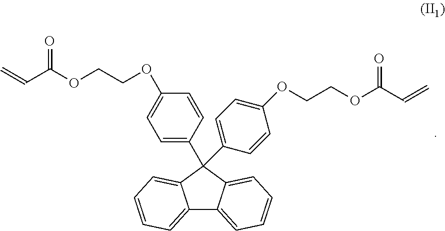

When added, the component (c) other monomers are used in an amount of preferably from 1 wt % to 50 wt %, more preferably from 5 wt % to 40 wt %, most preferably from 15 wt % to 30 wt %, based on the total weight of the polymerizable composition. In general, if the amount used of the monomer of the formula (II) is less than 1 wt %, the thermal stability of the polymerizable composition is not achieved. If the amount used of the monomer of the formula (II) is more than 50 wt %, the polymerizable composition obtained have too high viscosity to be favorable for coating.

In general, some of polyfunctional monomers or oligomers are added into the polymerizable composition as crosslinkling agents so as to increase the degree of crosslinkling between the molecules when polymerized and in turn to make the composition be easily cured and enhance the hardness of the coating after being cured. The (d) crosslinking agents can be optionally added into the polymerizable composition of the invention to increase the film-forming ability of the polymerizable composition of the invention. According to one preferred embodiment of the invention, oligomers are added into the polymerizable composition of the invention as crosslinking agents to increase the degree of crosslinkling between the molecules and enhance the hardness of the coating formed after curing the polymerizable composition to a pendulum hardness of 50 or more than 50. When the pendulum hardness is more than 80, the coating is brittle. Therefore, the pendulum hardness is preferably between 50 and 80. The above crosslinkling agents are well known to those people with ordinary common sense in the art and include, for example, but are not limited to, acrylate which can have one or more functional group(s), preferably more functional groups. The acrylate useful for the invention include, for example, but are not limited to (meth)acrylate such as tripropylene glycol di(meth)acrylate, 1,4-butanediol di(meth)acrylate, 1,6-hexanediol di(meth)acrylate, polyethyleneglycol di(meth)acrylate, allylated cyclohexyl di(meth)acrylate, isocyanurate di(meth)acrylate, ethoxylated trimethylol propane tri(meth)acrylate, propoxylated glycerol tri(meth)acrylate, trimethylol propane tri(meth)acrylate, tris(acryloxyethyl) isocyanurate; urethane acrylate such as aliphatic urethane acrylate or aromatic urethane acrylate; polyester acrylate such as polyester diacrylate; epoxy acrylate such as bisphenol-A epoxy diacrylate, novolac epoxy acrylate, etc; or a mixture thereof, preferably urethane acrylate, epoxy acrylate or a mixture thereof.

The component (d) acrylate oligomers which are commercially available and useful for the invention include, for example,

(meth)acrylate oligomers: EBECRYL-745 (produced by UCB Inc.); DOUBLEMER3778, DOUBLEMER1701, DOUBLEMER345, DOUBLEMER1703, DOUBLEMER530, DOUBLEMER570, DOUBLEMER236, and DOUBLEMER584 (produced by Double Bond Chemical Ind., Co., Ltd.,); 6530B-40, 6531B-40, 6532B-40, and 6533B-40 (produced by Eternal Chemical Co., Ltd.,).

Aliphatic urethane acrylate oligomers: 6101-100, 611A-85, 611B-85, 6112-100, 6113, 6114, 6115J-80, 6130B-80, 6131-1, 6134B-80, 6141H-80, 6143A-80, 6143C-60, 6144-100, 6145-100, 6145-100H, 6148J-75, 6148T-85, 6149-100, 615-100, 6150-100, 6151, 6152B-80, 6154B-80, 6157B-80, 6158B-80, 6160B-70, 6161-100, 6181 and 6196-100 (produced by Eternal Chemical Co., Ltd.,); AgiSyn™ 230T1 and AgiSyn™ 230A2 (produced by AGI Corporation); EBECRYL-264, EBECRYL-4820, EBECRYL-270, EBECRYL-230, EBECRYL-284 and EBECRYL-1290 (produced by UCB Inc.); HENKEL 6010 (produced by COGNIS Corporation); CN9001, CN9002, CN9004 and CN9006 (produced by Sartomer Corporation); Desmolux® U100, Desmolux® VP LS 2265, Desmolux® VP LS 2308, Desmolux® U375H, Desmolux® VP LS 2220, Desmolux® XP 2491, Desmolux® XP 2513, Desmolux® U200 and Desmolux® XP 2609 (produced by Bayer Corporation).

Aromatic urethane acrylate oligomers: 6120E-80, 6121F-80, 6122F-80 and 6146-100 (produced by Eternal Chemical Co., Ltd.,); 670T1, AgiSyn™ 670A2 (produced by AGI Corporation); EBECRYL-204, EBECRYL-205, EBECRYL-210, EBECRYL-215, EBECRYL-220 and EBECRYL-6202 (produced by UCB Inc.,).

Polyester acrylate oligomers: EBECRYL-830 and EBECRYL-524 (produced by UCB Inc.,); 6315, 6320, 6323-100, 6325-100, 6327-100, 6336-100 and 6361-100 (produced by Eternal Chemical Co., Ltd.,).

Epoxy acrylate oligomers: AgiSyn™ 1010, AgiSyn™ 1010A80, AgiSyn™ 1010B80, AgiSyn™ 1010080 (produced by AGI Corporation); 621, 622, 623-100, 6210G, 624-100, 6231, 6241, 6213-100, 6215-100, 625, 6261 and 620-100 (produced by Eternal Chemical Co., Ltd.,); EBECRYL-600, EBECRYL-605, EBECRYL-648, EBECRYL-1608, EBECRYL-3105, EBECRYL-3416, EBECRYL-3700, EBECRYL-3701, EBECRYL-3703, EBECRYL-3708 and EBECRYL-6040 (produced by UCB Inc.,).

When added, the (d) crosslinking agents are used in an amount of from 1 wt % to 60 wt %, preferably from 10 wt % to 50 wt %, more preferably from 20 wt % to 45 wt %, based on the total weight of the polymerizable composition.

In addition to the possible components mentioned-above, any conventional additives can be optionally added into the composition of the invention so as to modify the physical or chemical performances thereof. The additives useful for the invention is generally selected from the group consisting of a diluent, an inorganic filler, an anti-static agent, a slip agent, a surfactant, a leveling agent, a defoamer and a combination thereof.

The viscosity of the polymerizable composition depends on such factors as the variety and the content of the components of the composition, the operating temperature etc. According to the invention, the diluent can be optionally added into the polymerizable composition to adjust the viscosity of the polymerizable composition. The above diluent is preferably acrylate monomers. Suitable diluent includes, for example, but are not limited to (meth)acrylate, 2-phenoxylethyl acrylate, 2-(2-ethoxyethoxy)ethyl acrylate, trimethylolpropane triacrylate, polyethylene glycol diacrylate, polyethylene glycol o-phenylphenyl ether acrylate, cumyl phenoxyl ethyl acrylate, biphenylepoxyethyl acrylate, bisphenol-A epoxy diacrylate, novolac epoxy acrylate, propoxylated neopentyl glycol diacrylate, ethoxylated trimethylolpropane triacrylate, propoxylated trimethyloipropane triacrylate, dipentaerythritol hexaacrylate (DPHA) and a combination thereof. The examples of the commercially available acrylate monomers include for example, those with the trade names SR454®, SR494®, SR9020®, SR9021® or SR9041® produced by Sartomer Corporation; those with the trade names EM211®, EM224®, EM231® produced by Eternal Chemical Co., Ltd.

In order to enhance the hardness of the coating formed by curing the composition, the inorganic filler can be optionally added into the composition to avoid the optical properties from being affected by the collapse of the light-gathering structure. Further, the inorganic filler also has an efficacy of enhancing the luminance of the panels of the liquid crystal displays. The inorganic fillers useful for the invention are well known to those people with ordinary common sense in the art and include, for example, but are not limited to zinc oxide, silicon dioxide, strontium titanate, zirconium oxide, aluminium oxide, calcium carbonate, titanium dioxide, calcium sulfate, barium sulfate or a mixture thereof, preferably titanium dioxide, zirconium oxide, silicon dioxide, zinc oxide, or a mixture thereof. The above inorganic fillers have a particle size of from about 10 nm to about 350 nm, preferably from 50 nm to 150 nm.

The anti-static agents can be optionally added into the polymerizable composition to make it have anti-static effect and further increase a yield rate. The anti-static agents useful for the invention are well known to those people with ordinary common sense in the art and include, for example, but are not limited to ethoxy glycerin fatty acid esters, quaternary ammonium compound, fatty amine derivatives, epoxy resin (such as polyethylene oxide), siloxane or other alcohol derivatives (such as poly(ethylene glycol) ester or poly(ethylene glycol) ether), etc.

The polymerizable composition of the invention can be applied onto a substrate or an optical thin sheet (for example, any conventional diffusion film or light-gathering film) to form a coating of an optical film. The coating has a light-gathering structure and increases wear resistance of a surface and provides excellent smoothness. Further, since the polymerizable composition of the invention comprises the monomer of the formula (I) having a high refractive index, the coating formed from the polymerizable composition has a high refractive index. The coating of the invention has a refractive index of at least 1.53, preferably from 1.57 to 1.63, and thus is effective in enhancing the luminance of the optical thin sheet.

The above substrate can be any of the substrates known to those people with ordinary common sense in the art, for example glass or plastic. The above plastic substrate consists of one or more layer(s) of polymer resins. The varieties of the resins constituting the polymer resin layers mentioned-above are not particularly limited, and for example are selected from the group consisting of polyester resin such as polyethylene terephthalate (PET) or polyethylene naphthalate (PEN); polyacrylate resin such as polymethyl methacrylate (PMMA); polyolefin resin such as PE or PP; polycycloolefin resin; polyimide resin; polycarbonate resin; polyurethane resin; triacetyl cellulose (TAC); polylactic acid, and a combination thereof, but are not limited thereto. Among them, preference is given to one selected from the group consisting of polyester resin, polycarbonate resin and a combination thereof, with polyethylene terephthalate being most preferred. The thickness of the substrate usually depends on the requirement of the desired optical product, and is generally between 30 μm and 300 μm.

The invention further provides an optical film comprising a substrate and at least a layer of coating formed from the above polymerizable composition. The optical film of the invention is used in backlight units for the displays as a brightness enhancement film.

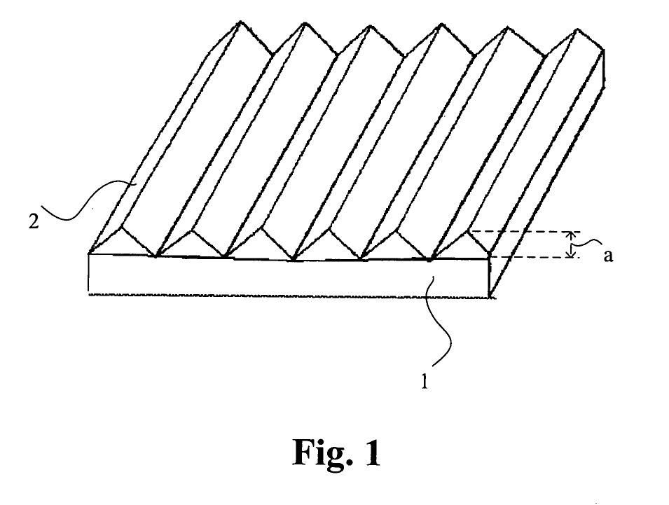

FIG. 1 is a schematic view of an embodiment of the optical film of the invention. As shown in FIG. 1, the optical film of the invention comprises a substrate (1) and a coating (2) exhibiting a light-gathering structure.

The coating of the optical film of the invention generally has a thickness of from 1 μm to 100 μm, preferably from 10 μm to 40 μm, most preferably 15 μm to 25 μm. When the coating has a specific structure, the thickness of the coating is represented by the highest point of the structure. For the optical film shown in FIG. 1, the thickness of the coating (2) is represented by symbol a.

According to one embodiment of the invention, the coating has light-gathering structures. The light-gathering structures of the optical film of the invention are well known to those people with ordinary common sense in the art and include, for example, but are not limited to, regular or irregular prismatic columnar structure (i.e., triquetrum), arc columnar structure (i.e., the peak of the columnar structure shows circular arc shape), lens-like structure and capsule-like structure, or a combination thereof, with prismatic columnar structure or arc columnar structure being preferred. The prismatic columnar structure and/or arc columnar structure mentioned-above may be linear, zigzag or serpentine. Preference is given to a linear prismatic columnar structure. Two adjacent columnar structures may be parallel or non-parallel to each other. In order to reduce optical interference, the light-gathering structure layer of the invention may comprise at least two or more columnar structures which are non-parallel to each other. The above columnar structure may be prismatic columnar structure or arc columnar structure or a combination thereof, with prismatic columnar structure being preferred. According to the invention, the light-gathering structure layer comprises at least one set of two crossed, non-parallel prismatic columnar structures and/or at least one set of two non-crossed, non-parallel prismatic columnar structures.

The optical film of the invention can be made by any method known to those people with ordinary common sense in the art. For example, it may be produced by the method comprising the steps as follows:

(1) mixing the monomer of the formula (I) with the photo-initiator, and if desired, the monomer of the formula (II), the crosslinking agents and other additives, to form a colloidal polymerizable composition;
(2) applying the colloidal polymerizable composition obtained in step (1) onto a substrate in an appropriate way to form a coating, and then forming a light-gathering structure on the coating for examples with an embossing roller; and
(3) curing the above coating by for example irradiation with energetic radiation at ambinet temperature or under heating.

Optionally, each of the above steps can be repeated to obtain an optical film comprising a plurality of the layer of coatings.

In order to avoid the surface of the substrate from being scratched and further affecting the optical properties of the film, a scratch-resistant layer can be optionally formed on another surface of the substrate opposite to the coating formed from the polymerizable composition of the invention. The scratch-resistant layer can be smooth or non-smooth. The thickness of the scratch-resistant layer is preferably between 0.5 μm pan and 30 μm. The optical film of the invention has a haze of from 1% to 90%, preferably form 5% to 40%, as measured according to JIS K 7136 standard method. The optical film of the invention has a total light transmittance of not less than 60%, preferably more than 80%, more preferably 90% or more, as measured according to JIS K 7136 standard method.

The polymerizable composition of the invention has a high refractive index of at least 1.53, so the optical film prepared from the polymerizable composition of the invention have a high refractive index. The optical film can be used in backlight units for displays as a brightness enhancement film so as to provide a good optical gain. Further, since the coating does not include halogens and in turn does not bring about environmental pollutions, hence the problems present in the prior art can be effectively solved. In addition, the polymerizable composition of the invention has a good leveling effect and has an economical advantage in low cost.

The invention is further illustrated by ways of the following examples.

### Examples 1-6

The optical films of Examples 1-6 are prepared according to the following description. The components of the compositions of Examples 1-6 were listed in Table 1 below.

First, the components are mixed in the weight ratio listed in Table 1 below, and then stirred with 1,000 rpm at 50° C. to form a colloidal polymerizable composition.

The colloidal polymerizable composition was applied onto a PET substrate (U34®, produced by TORAY Company) to form a coating, and then a prismatic pattern was formed on the coating by an embossing roller. Thereafter, the coating was cured by irradiation with energetic radiation at normal temperature. The coating of the optical film has a thickness of 25 μm.

TABLE 1

| | component | | |
|---|---|---|---|
| | (a) | (b) | (d) |
| Example | (g) | (g) | (g) |
| 1 | 5 | 1.05 | 30 |
| 2 | 10 | 1.20 | 30 |
| 3 | 15 | 1.35 | 30 |
| 4 | 20 | 1.50 | 30 |
| 5 | 25 | 1.65 | 30 |
| 6 | 30 | 1.80 | 30 |

(a): the monomer of the formula (I) (2-(naphthalen-7-ylthio)ethyl acrylate, produced by Aldrich)
(b): the photo-initiator (I184 ®, produced by Ciba)
(d): the crosslinking agent (623-100 ®, produced by Eternal Chemical Co., Ltd)

The optical films of Examples mentioned-above were respectively tested for refractive index (using AUTOMATIC REFRACTOMETER GPR11-37® provided by Index Instruments Company) and used for the edge-lighting backlight unit with a size of 22 inch provided by BenQ for carrying out luminance gain test (using BM-7® instrument provided by TOPCON Company). The results are shown in Table 2 below.

TABLE 2

| Example | Refractive index | Luminance gain |
|---|---|---|
| 1 | 1.550 | 68.5% |
| 2 | 1.553 | 69.8% |
| 3 | 1.561 | 71.1% |
| 4 | 1.566 | 72.6% |
| 5 | 1.571 | 73.0% |
| 6 | 1.575 | 73.8% |

It can be seen from the results of Examples 1-6 listed in Table 2 that the coatings formed from the polymerizable composition of the invention have a refractive index of more than 1.55, and can achieve a better light-gathering effect due to the fact that when used for backlight units, the refractive index of the coating is in proportion to the luminance gain, that is, the higher is the refractive index of the coating, the more is the luminance gain.

### Examples 7-10

The way to prepare the optical films of Examples 1-6 was repeated.

The components of the compositions of Examples 7-10 were listed in Table 3 below.

TABLE 3

components

| | (a) | (b) | (c) | (d) |
|---|---|---|---|---|
| Examples | (g) | (g) | (g) | (g) |
| 6 | 30 | 1.8 | 0 | 30 |
| 7 | 30 | 1.95 | 5 | 30 |
| 8 | 30 | 2.10 | 10 | 30 |
| 9 | 30 | 2.25 | 15 | 30 |
| 10 | 30 | 2.40 | 20 | 30 |

(a): the monomer of the formula (I) (produced by Aldrich)
(b): the photo-initiator (I184 ®, produced by Ciba)
(c): other monomer (A-BPEF, produced by Shin-Nakamura Chemical Co., Ltd)
(d): the crosslinking agent (623-100 ®, produced by Eternal Chemical Co., Ltd)

The optical films of Examples 6-10 were tested for thermal stability (using thermogravimetric analysis instrument such as Shimadzu TGA-50H). The results are shown in Table 4 below.

TABLE 4

| | | |
|---|---|---|
| Sample from Example 6 | Temperature (° C.) | 315.0 |
| | weight loss (%) | −5 |
| Sample from Example 7 | Temperature (° C.) | 323.3 |
| | weight loss (%) | −5 |
| Sample from Example 8 | Temperature (° C.) | 332.1 |
| | weight loss (%) | −5 |
| Sample from Example 9 | Temperature (° C.) | 342.3 |
| | weight loss (%) | −5 |
| Sample from Example 10 | Temperature (° C.) | 354.6 |
| | weight loss (%) | −5 |

It can be seen from the results listed in Table 4 that the cured film has a better thermal stability when the polymerizable composition of the invention is cured to form a film containing (c) other monomers.

Comparative Examples 1-2 were carried out according to the method for preparing the optical films of Example 1, except that the monomer of the formula (I) was replaced with the monomer of (a′) or (a″). The components of the compositions of Comparative Examples 1-2 were listed in Table 5 below.

TABLE 5

components

| | (a′) | (a″) | (b) | (d) |
|---|---|---|---|---|
| Comparative Example | (g) | (g) | (g) | (g) |
| 1 | 5 | 5 | 1.05 | 30 |
| 2 | 5 | 5 | 1.20 | 30 |

(a′): the monomer (EM 210 produced by Eternal Chemical Co., Ltd)
(a″): the monomer (EM 2108 produced by Eternal Chemical Co., Ltd)
(b): the photo-initiator (I184 ®, produced by Ciba)
(d): the crosslinking agent (623-100 ®, produced by Eternal Chemical Co., Ltd)

The optical films of Comparative Examples mentioned-above were respectively tested for refractive index (using AUTOMATIC REFRACTOMETER GPR11-37® provided by Index Instruments Company) and were used for the edge-lighting backlight unit with a size of 22 inch provided by BenQ for carrying out luminance gain test (using BM-7® instrument provided by TOPCON Company). The results are shown in Table 6 below.

TABLE 6

| Comparative | Refractive | Luminance |
|---|---|---|
| Example | index | gain |
| 1 | 1.529 | 63.4% |
| 2 | 1.533 | 64.8% |

It can be seen from the results listed in Table 6 that the coatings formed from the compositions of Comparative Examples 1-2 have a relatively low refractive index and thus have a relatively poor luminance gain effect due to the absence of the monomer of the formula (I), as compared to the composition of Example 1.

The above examples are used to exemplify the embodiments of the invention and illustrate the technical features of the invention, but not intended to limit the scope of the invention to be protected. Any modifications or alterations, that can be easily accomplished by those people with ordinary common sense in the art without departing from the technical principle and the spirit of the invention, fall within the scope of the disclosure of the specification and the appended claims.

What is claimed:

1. A polymerizable composition comprising
(a) 1-90 wt % of a monomer of a formula (I): 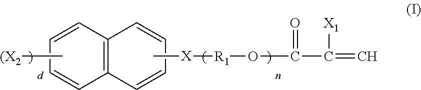
wherein
X₁ is H or methyl;
X₂ is H or C₁-C₂ alkyl;
X is O or S;
R₁ is C₁-C₁₂ straight or branched alkylene or alkoxylene; and
d and n are each independently an integer of 0 to 3; and
(b) 0.1-10 wt % of a photo-initiator,
based on the total weight of the polymerizable composition.

2. The composition according to claim 1 wherein (a) is a monomer of formula (I₁): 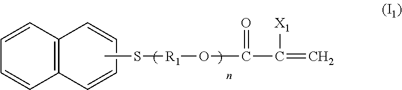
wherein
X₁ is H or methyl;
R₁ is methylene, ethylene, propylene or isopropylene;
n is an integer of 1 to 2.

3. The composition according to claim 1 wherein (a) is a monomer of formula (I₂):

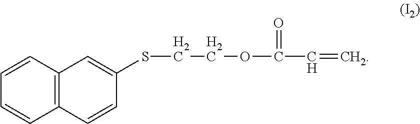

4. The composition according to claim 1 wherein the monomer of formula (I) is in an amount of from 8 wt % to 70 wt %, based on the total weight of the polymerizable composition.

5. The composition according to claim 1 wherein the photo-initiator is in an amount of from 1 wt % to 5 wt %, based on the total weight of the polymerizable composition.

6. The composition according to claim 1 further comprising (c) other monomers.

7. The composition according to claim 6 wherein the refractive index of (c) other monomers is not less than 1.6.

8. The composition according to claim 6 wherein (c) is a monomer of formula (II): 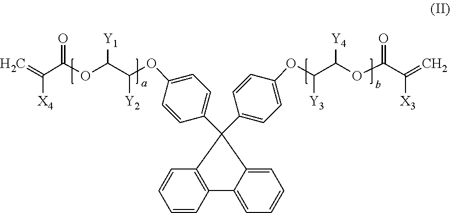
wherein
X₃ and X₄ are each independently H or methyl;
Y₁, Y₂, Y₃, and Y₄ are each independently H, C₁-C₂ alkyl, or OH; and
a and b are each independently an integer of 0 to 3.

9. The composition according to claim 8 wherein (c) is a monomer of formula (II₁):

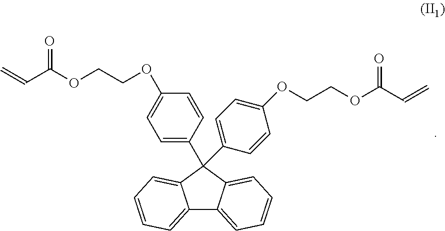

10. The composition according to claim 1 further comprising (d) a cross-linking agent.

11. The composition according to claim 10 wherein the cross-linking agent is a (meth)acrylate, urethane acrylate, polyester acrylate, epoxy acrylate or a combination thereof.

12. A optical film comprising a substrate and at least one coating formed from the polymerizable composition according to claim 1.

13. The optical film according to claim 12 wherein the coating forms a light-gathering structure.
